(19) United States
(12) Patent Application Publication
(10) Pub. No.: US 2021/0092945 A1
(43) Pub. Date: Apr. 1, 2021

(54) INSECT ERADICATION DEVICE

(71) Applicant: Saltshot, LLC, Aspen, CO (US)

(72) Inventor: Christopher Dillon, Glenwood Springs, CO (US)

(21) Appl. No.: 17/104,135

(22) Filed: Nov. 25, 2020

Related U.S. Application Data
(63) Continuation-in-part of application No. 16/548,618, filed on Aug. 22, 2019.
(60) Provisional application No. 62/721,406, filed on Aug. 22, 2018.
(60) Provisional application No. 62/769,734, filed on Nov. 20, 2018.

(51) Int. Cl. A01M 3/00; A01M 27/00; F41B 3/02

(52) U.S. Cl. CPC A01M 3/00; F41B 3/02; A01M 27/00

(57) ABSTRACT

An insect eradication device is disclosed having a projectile shooting assembly and a grip detachably coupled to the projectile shooting assembly. The grip includes a ring shaped holding portion having an aperture, the holding portion engages with an external circular lip on a rear side of the projectile shooting assembly, when the projectile shooting is inserted therein from a front side of the grip. A generally Y shaped locking member is fitted on the grip and locks the projectile shooting assembly in position. The grip has an inner hollow that is used to store projectiles used in the projectile shooting. The projectile shooting assembly is generally round in shape and is provided with a projection pouch that extends towards rear for a user to pull and release on which the projectiles are expelled from a nozzle on a front side of the shooting assembly.

### CROSS REFERENCE TO RELATED APPLICATION

This application is a continuation-in-part of and claims the benefit of U.S. patent application Ser. No. 16/548,618 which claims the benefit of Provisional U.S. Patent Application No. 62/721,406, filed Aug. 22, 2018, and entitled “INSECT ERADICATION DEVICE”, and Provisional U.S. Patent Application No. 62/769,734, filed Nov. 20, 2018, and entitled “INSECT ERADICATION DEVICE”, the entire contents and disclosures of which, both express and implied, are incorporated herein by reference.

### FIELD OF THE INVENTION

This invention relates to an insect eradication device. More particularly, the present invention relates to an elastic powered insect eradication device.

### BACKGROUND

The background description includes information that may be useful in understanding the present invention. It is not an admission that any of the information provided herein is prior art or relevant to the presently claimed invention, or that any publication specifically or implicitly referenced is prior art.

Certain insects or bugs, such as, flies, are a nuisance to humans and can spread diseases to people and domestic animals by biting or carrying disease causing pathogens. Conventionally a number of implements for swatting insects, such as, flyswatters require the user to chase down the fly and physically hit or smash the fly. This can create a situation where clean-up is required if the fly is actually hit/caught and killed. Insecticides or bug sprays use potentially harmful chemicals. Flytraps and fly tapes can be unsightly. Bug zappers may require batteries or electricity for operation. Accordingly, there is an ongoing need for an insect eradication device which can kill bugs which is safe, environment friendly, convenient, portable and cost effective.

### SUMMARY

There is a need for an insect eradication device that overcomes the above stated drawbacks of the conventional devices and methods for eradicating the insects. In particular, there is a need an insect eradication device that can kill bugs and is safe, environment friendly, convenient, portable and cost effective.

An improved insect eradication device is provided to solve the above described limitations of conventional devices presently known in the art to exterminate winged insects, such as, mosquitoes and flies. According to an embodiment, the disclosed insect eradication device uses salt to eradicate the insects. Salt is known to kill pests, such as slugs and snails, by absorbing fluids from their body and causing them to die of dehydration. The present device is configured to use salt as a projectile in order to kill insects/winged insects and bugs. However, the device can be used to shoot any other suitable materials, such as coarse salt, rock salt, BBs, airsoft BBs, plastic balls, pellets, dirt and sand as a projectile to kill insects.

According to an embodiment, the proposed insect eradication device can be configured to expel a projectile, such as but not limited to salt, from a front side of the projectile shooting assembly; and a grip assembly configured for detachable attachment to the projectile shooting assembly. The grip assembly includes a grip having a ring shaped holding portion and a generally Y shaped locking member. The ring shaped holding portion of the grip has an aperture and is configured to engage with an external circular lip on a rear side of the projectile shooting assembly, when the projectile shooting assembly is inserted therein from a front side of the grip.

The locking member is configured to be fitted on the grip such that, when fitted the on the grip, the locking member locks the projectile shooting assembly in position in engagement with the holding portion of the grip.

The locking member and the grip may incorporate matching male and female engagement features that allow the locking member lo be slid up relative to the grip after the male and the female engagement features have been aligned. After the locking member has been fully moved up, an upper portion of the locking member overlaps with a front side of the projectile shooting assembly to lock the projectile shooting assembly in position.

The upper portion of the locking member may be substantially semicircular that gives the locking member the Y shape.

The grip may be hollow from inside such that the inner hollow can store the projectile for use with the projectile shooting assembly. The grip may include at least one opening to fill and remove the stored projectile from inner hollow. There may be silicon plugs provides to close each of the at least one opening.

According to an embodiment, the projectile shooting assembly includes a generally round shape housing having a thickness along an axis of the housing, a front side and a rear side. Both the rear side and the front side respectively have a rear opening and front opening that are concentric to the axis of the housing. The projectile shooting assembly further includes a pouch holder that is configured for being accommodated within the housing; and a projection pouch configured for fitment at a rear end of the pouch holder such that when the pouch holder is accommodated within the housing, a major portion of the projection pouch projects out of the rear side of the housing. The projection pouch is configured such that when a rear tip of the projection pouch is pulled back and released, the projectile filled in the projectile shooting assembly gets expelled from the front side of the device to eradicate insects.

The projectile shooting assembly may include a front cover that can be pivotally fixed to the front side of the housing. The front cover can have a cover opening that is concentric to the axis of the housing. The front cover, when in a closed position, can cover the front opening of the housing.

The pouch holder may be of annular shape and may include a groove on outer periphery near a rear end of the pouch holder. The groove can be configured for fitment of a front end of the projection pouch.

The rear end of the pouch holder may larger than a front end, such that the pouch holder works to converge the shot being expelled from the projectile shooting assembly.

The pouch holder may include a plurality of lugs located on an outer periphery of the pouch holder such that, when the pouch holder is fitted within the housing, the plurality of lugs engage with corresponding recesses in the housing to locate the pouch holder in the housing.

In an embodiment of the pouch holder, the pouch holder may have a single piece/unit construction (that is, it may be formed from a single unit). In an alternate embodiment, the pouch holder can involve a two piece construction comprising a front pouch holder that has a shape that converges toward the front side, and a rear pouch holder having the groove on outer periphery for fitment of the projection pouch. The front pouch holder and the rear pouch holder may be configured for assembly to each other through a combination of lugs and recesses provided on outer peripheries of the front pouch holder and the rear pouch holder.

The projectile shooting assembly may further include a cone shaped nozzle configured for fitment in the housing towards a front side of the pouch holder. The nozzle may be configured such that in a first mode of fitment its narrower end is towards the front side of the projectile shooting assembly and projects out of the front cover. In a second mode of fitment the nozzle can be fitted with its larger end toward the front side of the projectile shooting assembly and the nozzle is fully accommodated within the housing to enable closing of the front opening of the front cover.

The projectile shooting assembly may include a front cap to close the front cover opening of the front cover after the nozzle has been fitted in the second mode of fitment, and a rear cap to close the rear opening of the hosing after the projection pouch has been compressed within the housing.

The projection pouch is reinforced with a plurality of longitudinally ribbed elements, and a rear tip of the projection pouch may be reinforced to protect against wear and tear.

The projectile shooting assembly may include a picatinny rail or bracket configured to receive at least one apparatus selected from a group consisting of a laser, a flash light, a pointer, an aiming apparatus, a camera, a phone and a LED light.

Various objects, features, aspects and advantages of the inventive subject matter will become more apparent from the following detailed description of preferred embodiments, along with the accompanying drawing figures in which like numerals represent like components

### BRIEF DESCRIPTION OF THE DRAWINGS

FIGS. 1A and 1B illustrate exemplary front and rear perspective views respectively of the disclosed insect eradication device, in accordance with an embodiment.

FIGS. 2A and 2B illustrate exemplary perspective views from a front side and a rear side respectively of a shooting assembly, in accordance with an embodiment.

FIG. 2C illustrates an exemplary sectional view of the shooting assembly, in accordance with an embodiment.

FIGS. 3A and 3B illustrate different exemplary views of the grip of the insect eradication device of FIGS. 1A and 1B, in accordance with an embodiment.

FIG. 3C illustrates the grip and a side plate of the grip, in accordance with an embodiment.

FIGS. 4A to 4C illustrate grip assembly with the grip and a locking member, and a method of assembling the locking member to the grip, in accordance with an embodiment.

FIG. 5 illustrates the projectile shooting assembly being inserted in an aperture of the grip from a front side with the grip, in accordance with an embodiment.

FIG. 6 illustrates an exemplary view of a projection pouch of the projectile shooting assembly, in accordance with an embodiment.

FIGS. 7A and 7B illustrate exemplary views showing details of a pouch holder, in accordance with an embodiment.

FIGS. 8A to 8E illustrate method of assembling the projectile shooting assembly, in accordance with an embodiment.

FIG. 9 illustrates an exemplary perspective view of a nozzle of the projectile shooting assembly, in accordance with an embodiment.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms are used herein. To the extent a term used in a claim is not defined, it should be given the broadest definition persons in the pertinent art have given that term as reflected in printed publications and issued patents at the time of filing.

Conventional devices used for eradicating harmful insects and bugs have many drawbacks. For example, it is not easy to swat insects using a fly swatter as the user is required to chase the fly and physically hit or smash the fly, reducing the chances of the targeted insect being hit. A more convenient method to eradicate insects is to use insecticides. However, the insecticides have harmful effect on human, if exposed. After spraying the insecticide, the area is out of bonds for some time. Flytraps and fly tapes affect aesthetics, and bug zappers require batteries or electricity for operation.

The insect eradication device disclosed herein can be used for eradicating insects in a manner overcomes the above stated drawbacks of conventional devices for eradicating insects. The insect eradication device is ergonomically convenient to hold while in use. It is light weight and can also be conveniently carried around by the user. The insect eradication device also allows for projectile storage inside the device or in a grip attached to the device. Conveniently, the insect eradication device can use commonly available table salt as a projectile. The insect eradication device is also easy to assemble and disassemble.

In an embodiment, the disclosed insect eradication device (also referred to simply as device hereinafter) uses salt as a projectile. The kinetic energy/impact of the salt results in killing or eradicating the target insect. It is to be appreciated that the terms projectile and salt are used interchangeably in this document. The term “projectile”, as used in this document, includes common table salt, coarse salt, rock salt, metallic ball projectiles such as BBs, airsoft BBs, plastic ball projectiles, pellets, dirt, sand and other material that can be used as a projectile to kill insects.

In an embodiment, the disclosed device includes a generally round shaped projectile shooting assembly (also referred to simply as shooting assembly and the two terms used interchangeably hereinafter) that is detachably coupled to a grip assembly. The grip assembly is ergonomically designed and is configured to store projectile for use with the projectile shooting assembly.

In another embodiment, the projectile shooting assembly is operated by pulling a projectile pouch (also referred to simply as pouch and the two terms used interchangeably hereinafter) towards rear, i.e. towards a user of the device, and released, which causes projectiles/salt filled in the projectile shooting assembly to be expelled towards front through a nozzle that can be pointed to the insects to be eradicated. The projectile shooting assembly can also include an aiming device fitted on a rail, such as, a picatinny rail, of the projectile shooting assembly to direct the projectile to a targeted position.

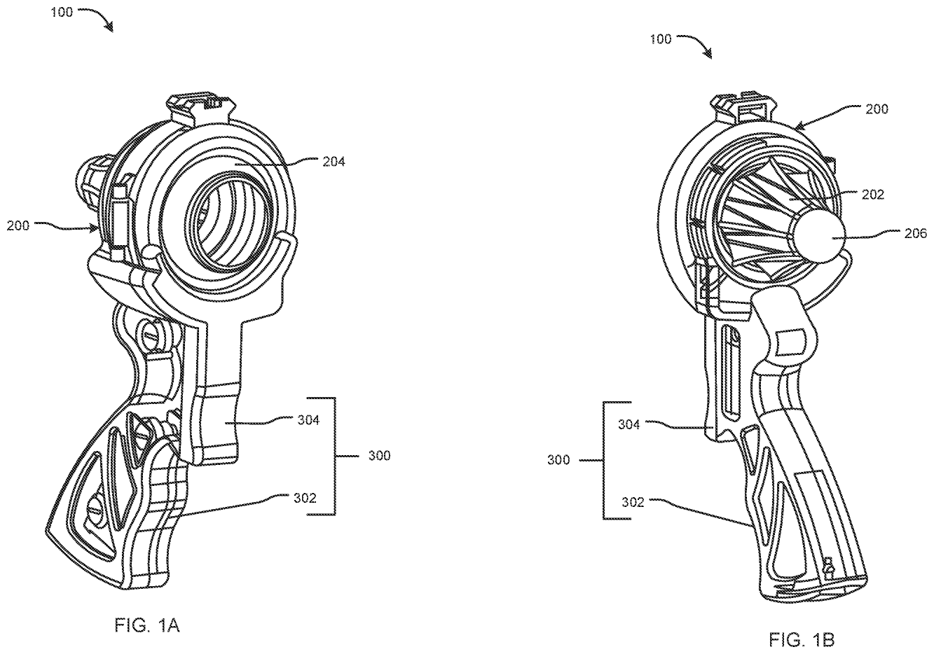

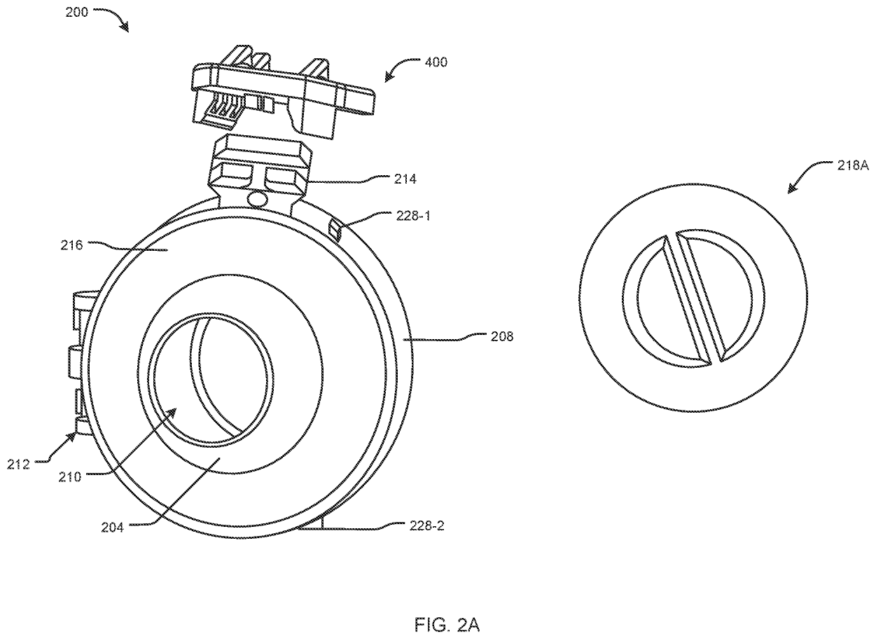

Referring now to FIGS. 1A and 1B, where perspective views of the proposed insect eradication device from a front side and rear side of the device respectively, are disclosed, the insect eradication device 100 includes a projectile shooting assembly 200 and a grip assembly 300. The projectile shooting assembly is detachably coupled to the grip assembly 300. The grip assembly 300 includes a grip 302 and a locking member 304. The locking member 304 enables to detachably couple the projectile shooting assembly 200 to the grip 302. Also shown in FIGS. 1A and 1B are the projectile pouch 202 located on the rear side of the device 100, a tip 206 of the pouch 202 and the nozzle 204 located on the front side of the device 100.

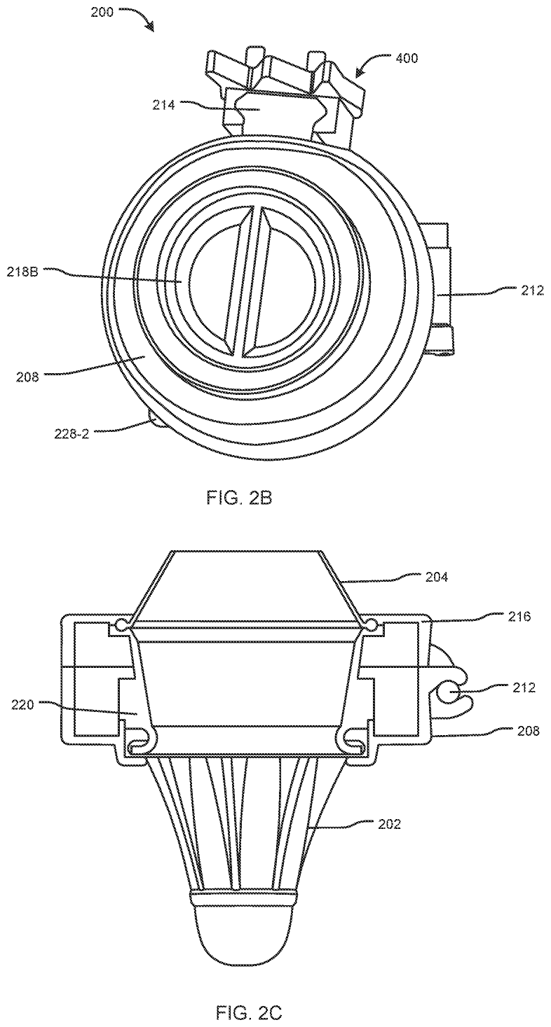

FIGS. 2A to 2C illustrate different views of the projectile shooting assembly 200, wherein FIG. 2A illustrates a front view of the projectile shooting assembly 200 showing the shooting assembly 100 fitted with a nozzle 104 with a front cap 218A shown alongside that can be fitted after fitment of the nozzle 204 has been reconfigured, while FIG. 2B illustrates a rear view of the projectile shooting assembly 200 fitted with a rear cap 208B. FIGS. 2A to 2C further show a housing 208 of the projectile shooting assembly 200 and a front cover 216 (also referred simply as cover and the two terms used interchangeably hereinafter) that covers a front opening 210 of the housing 208. The front cover 216 includes a cover opening through which the nozzle 204 projects out of the front cover 216. The front cover 216 can be pivotally fixed to the housing 208 by a hinge 212. The front cover 216, on being closed over the housing 208, may get locked by a locking means, not shown here, which may be unlocked to open the front cover by using a pair of buttons 228-1 and 228-2 (collectively buttons 228). However, in another embodiment, the front cover can be opened by using a single button.

According to an embodiment, when the shooting assembly 200 is not in use, the nozzle 204 can be fitted in the housing in a manner that it does not project out of the front cover 216, and thereafter the front cap 218A can be fitted to close the cover opening.

According to an embodiment, the housing 208 can include a rail 214, such as a picatinny rail, fitted on an upper side of the housing, and the rail 214 can be configured to hold an aiming device 400, such as but not limited to a laser and pointer. The rail 214 may also be used to fix other apparatuses such as a flash light, a pointer, a camera, a phone or a LED light.

Referring to FIGS. 2B and 2C, a rear side of the housing 208 has a rear opening through which the pouch 202 projects out. When not in use, the rear opening may be closed by the rear cap 218B that is similar to a front cap 218A, after the pouch 202 has been compressed within the housing 208. Both the front cap 218A and the rear cap 218B, when placed on the cover opening of the front cover 216 and the rear opening of the housing 208, can prevent the outward projection of the pouch 202 to the respective side.

Shown in FIG. 2C is a pouch holder 220 (also referred to simply as holder and the two terms used interchangeably hereinafter) that holds the pouch 202 around its circumference at a rear end of the holder 220, and the nozzle 204 located towards a front side of the holder 220.

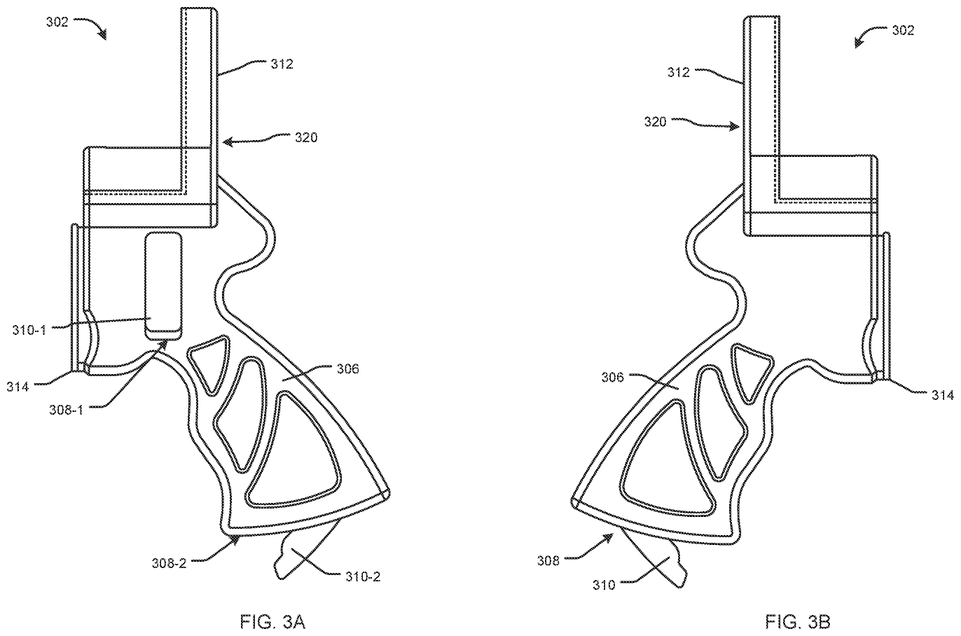

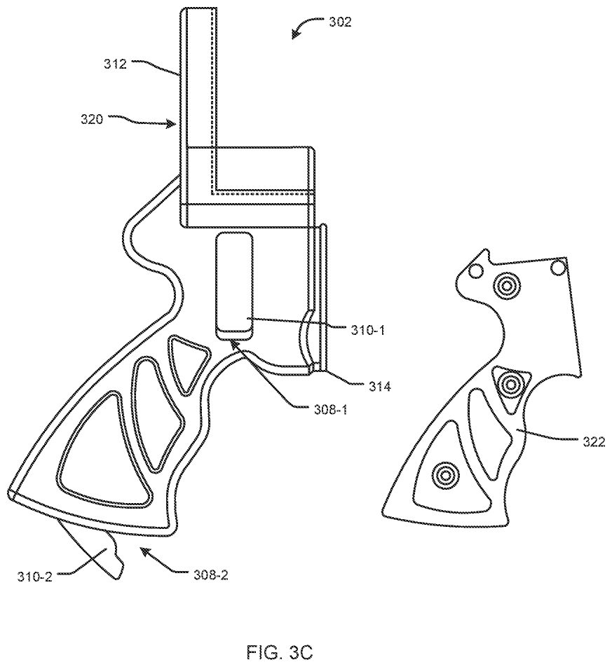

FIGS. 3A and 3B show different views of the grip 302 of the insect eradication device 100. The grip 302 can be hollow from inside such that an inner hollow 306 can store the projectile for use with the projectile shooting assembly 200. The grip 302 may include at least one opening, such as openings 308-1 and 308-2 (collectively referred to as opening 308) to fill and remove the stored projectile from inner hollow 306. There may be silicon plugs 310-1 and 310-2 (collectively referred to as plug 310) to close each of the opening 308.

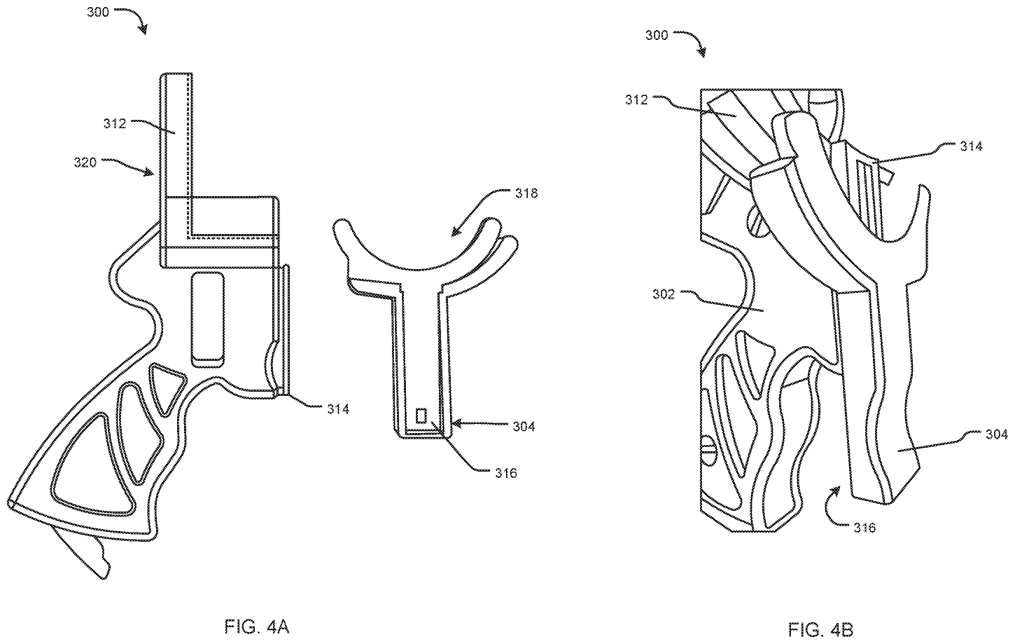

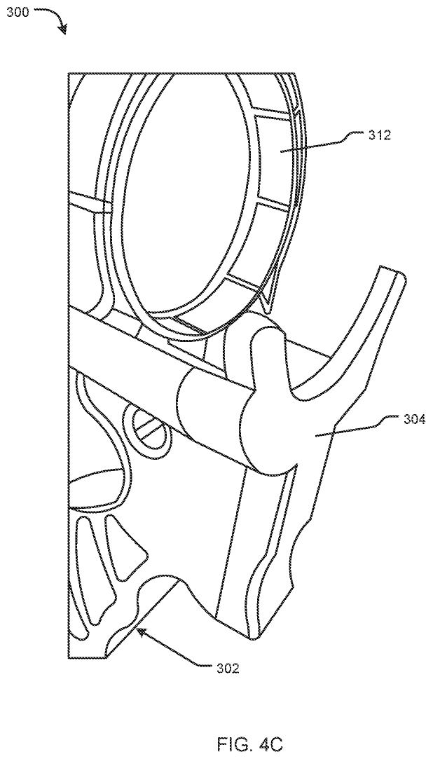

For facilitating the detachable coupling of the grip assembly 300 and the projectile shooting assembly 200, the grip 302 can include a ring shaped holding portion 312. The holding portion 312 of the grip 302 has an aperture 320 and is configured to engage with an external circular lip on a rear side of the projectile shooting assembly 200, i.e. on the housing 208. When the projectile shooting assembly 200 is inserted in the aperture 320 from a front side of the grip 302, the holding portion 312 restricts further travel of the projectile shooting assembly 200. Forward travel of the projectile shooting assembly 200 is restricted by the locking member 304, when fitted as shall be described in subsequent paragraphs. Further, for fitment of the locking member 304 with the grip 302, the grip 302 includes a male engagement feature 314 that matches a corresponding female engagement feature 316 of the locking member 304, shown in FIG. 4A.

FIG. 3C shows a side plate 322 configured for fitment to an open side of the grip 302 such that when the side plate 322 is fitted to the grip 302, it closes a cavity in the grip 302 to provide the inner hollow 306.

FIGS. 4A to 4C show the details of the locking member 304 and manner of its fitment on the grip 302. As shown, an upper portion 318 of the locking member 304 can be substantially semicircular that gives the locking member 304 a generally Y shape. The locking member 304 includes the female engagement features 316 that corresponds to the male engagement feature 314 of the grip 302. The matching male and female engagement features 314 and 316 allow the locking member 304 lo be slid up relative to the grip 302 after the male and the female engagement features 314 and 316 have been aligned, as shown in FIG. 4B. After the locking member 304 has been fully moved up, as shown in FIG. 4C, an upper semicircular portion 318 of the locking member 304 overlaps and rests against a front side face of the projectile shooting assembly 200 to restrict its movement away from the holding portion 312 of the grip to lock the projectile shooting assembly 200 in position.

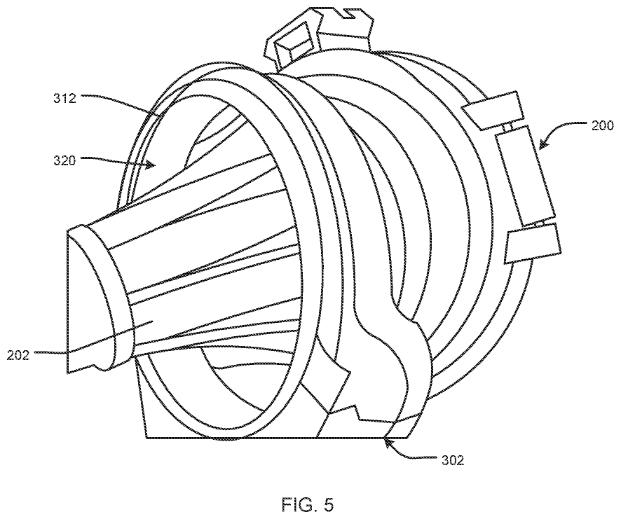

FIG. 5 shows the projectile shooting assembly 200 being inserted in the aperture 320 from a front side with the grip 302. After the projectile shooting assembly 200 has been inserted in the aperture 320 of the grip 302 the locking member 304 can be positioned to align the male and female engagement features 314 and 316, as shown in FIG. 4B and thereafter the locking member 304 can be moved up fully home, as shown in FIG. 4C, such that the upper semicircular portion 318 of the locking member 304 overlaps and rests against a front side face of the projectile shooting assembly 200 to restrict its movement away from the holding portion 312 of the grip to lock the projectile shooting assembly 200 in position.

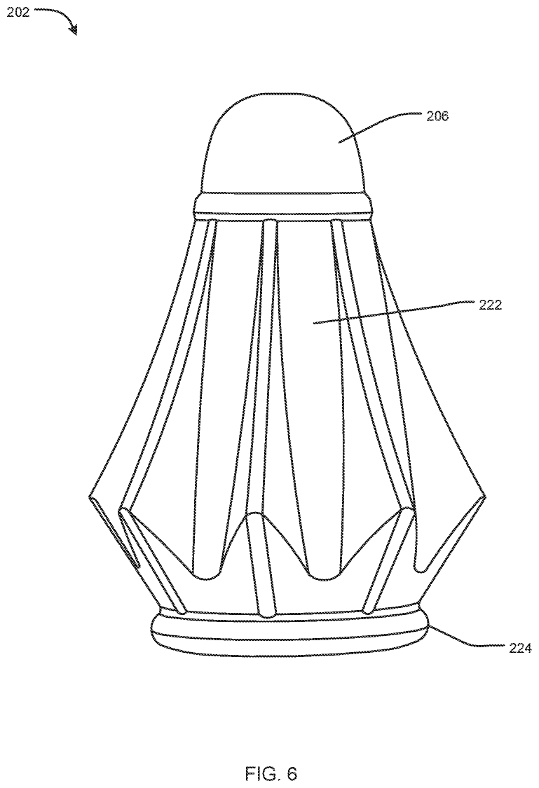

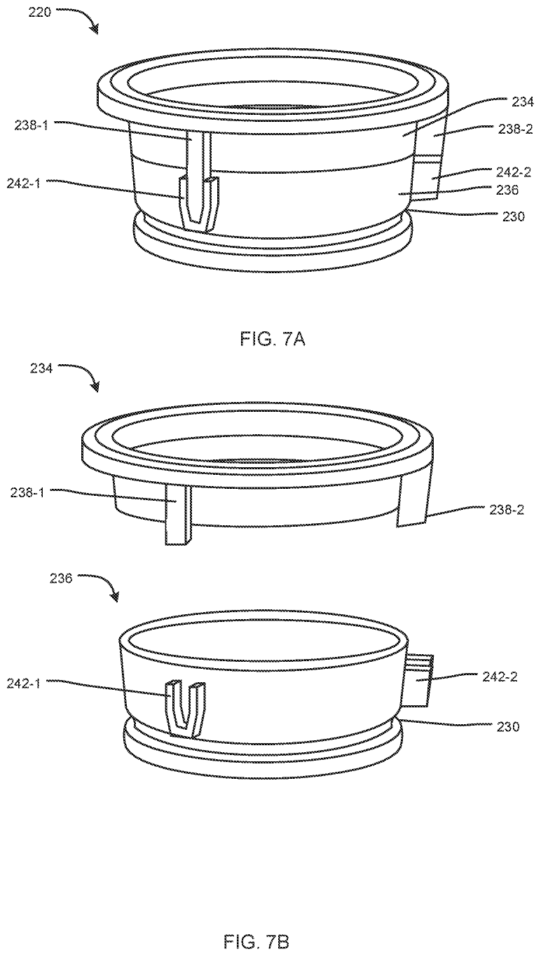

FIG. 6 shows a front view of the projection pouch 202. The pouch 202 can be made of rubber or any other elastic material to function like a slingshot. The pouch 202 can be of generally conical shape having a tip 206 (also referred to as rear tip 206) and a lip 224 on the other end, referred to as mouth of the pouch 202. The lip 224 is configured to fit in a corresponding groove 230 (refer to in FIG. 7A) in the pouch holder 220 for coupling of the pouch 202 with the pouch holder 220. As shown, the pouch 202 can be reinforced with a plurality of ribbed elements 222 to enhance its strength. Since maximum stress is applied to the tip 206 of the pouch, it can be reinforced, for example, with a thicker material, to protect the pouch from tears as it is stretched out to shoot the projectile. When fitted in the projectile shooting assembly 200, the tip 206 projects out of the housing of the projectile shooting assembly 200 to enable a user to hold it and pull in rear direction. In an embodiment, the pouch 202 can be compressed within the housing using a complemental male connector (not shown). This prevents the pouch 202 from projection out of the housing 208 of the projectile shooting assembly 200, and in that position a rear cap 218B can be placed over the rear opening of the housing 208 as shown in FIG. 2B. According to an embodiment, the front cap 218A and the rear cap 218B, when placed on the cover opening of the front cover 216 and the rear opening of the housing 208, can prevent the outward projection of the pouch 202 to the respective side.

In an embodiment, pouch 202 can be made in different sizes to meet the requirement of amount of projectile and the distance to which the projectile is to be shot. In certain embodiments, the tip 206 of the pouch can include a colored end/tip. This facilitates proper holding of the pouch. The pouch 202 can also include printed line/lines which glow in the dark for aiming. This aiming line can continue from the pouch to over the device body.

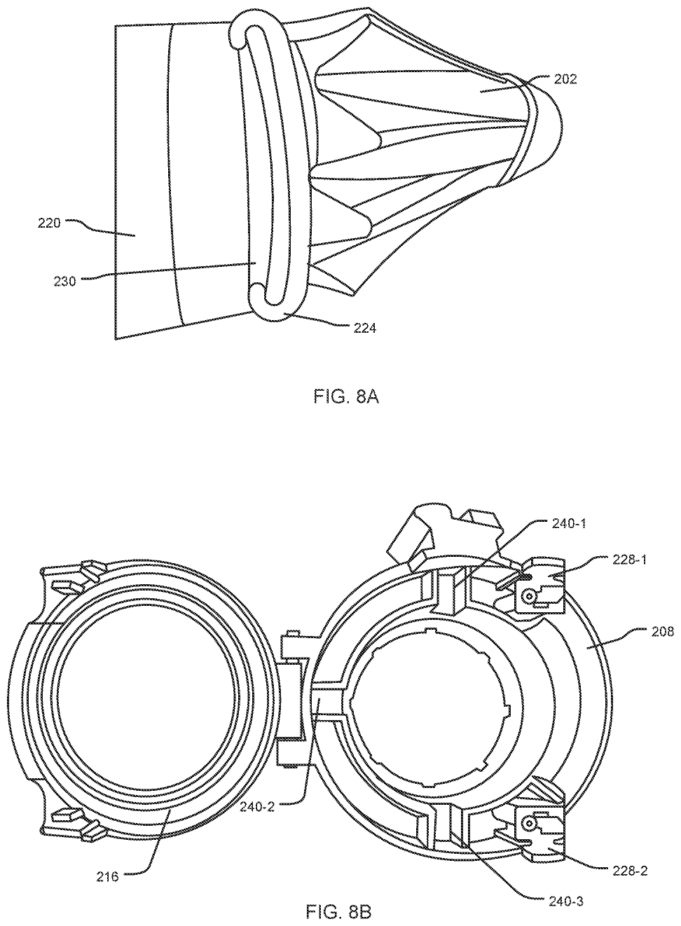

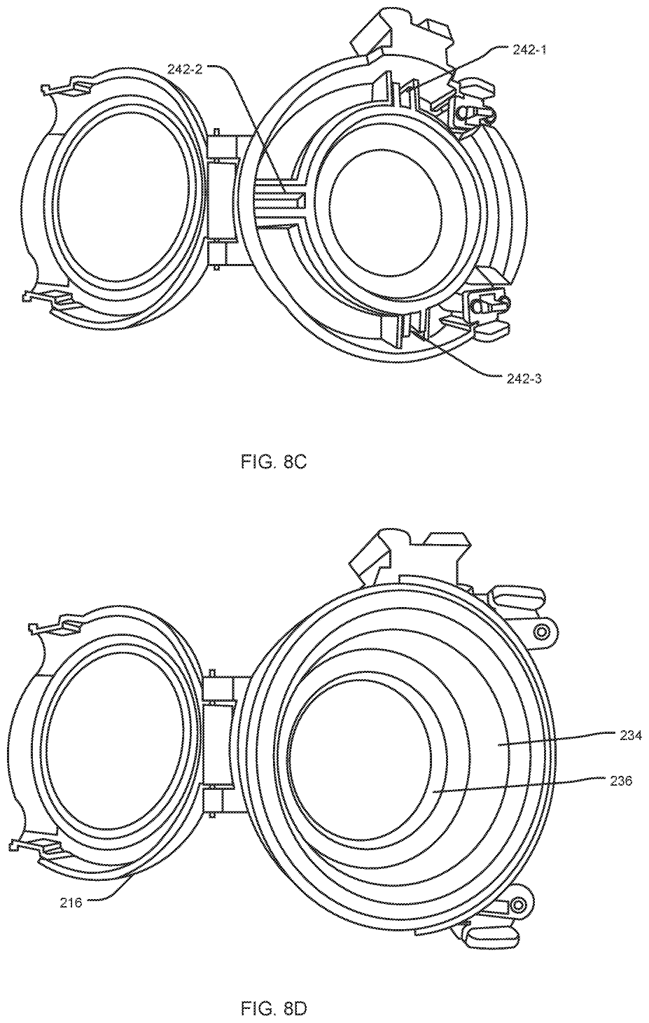

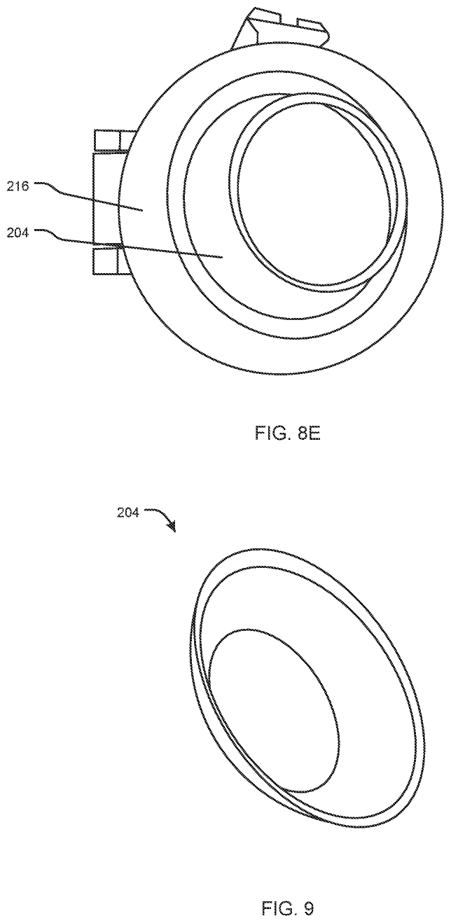

FIG. 7A shows a two piece pouch holder 220, and FIG. 7B shows a front pouch holder 234 and a rear pouch holder 236, which together constitute the two piece pouch holder 220 of FIG. 7A. The front pouch holder 234 has a converging shape that converges toward the front side of the shooting assembly 200, i.e. upper side in FIG. 7B. The rear pouch holder 236 includes the groove 230 on outer periphery for fitment of the pouch 202. The front pouch holder 234 and the rear pouch holder 236 may be configured for assembly to each other through a combination of lugs, such as male lugs 238-1 and 238-2 (hereinafter collectively referred to as male lugs 238), on the outer periphery of the front pouch holder 234 and female lugs, such as female lugs 242-1 and 242-2 (hereinafter collectively referred to as female lugs 242, also referred to simply as lugs 242), provided on outer periphery of the rear pouch holder 236. The female lugs 242 may be U-shaped such that the male lugs 238 can engage with the U-shaped female lugs 242 when the front pouch holder 234 is assembled with the rear pouch holder 236, as shown in FIG. 7A. The female lugs 242 are further configured to engage with corresponding recesses 240, shown in FIG. 8B, in the housing 208 to locate the pouch holder 220 in the housing 208 when the pouch holder 220 is placed within the housing 208.

In an alternate embodiment, the pouch holder can be a single piece pouch holder having same shape as of the assembled two-piece pouch holder 220 with lugs, which are similar in outer profile to the female lugs 242, located on the outer periphery, and can have the groove 230 located on the rear side of the shooting assembly 200.

FIGS. 8A to 8E illustrate the manner of assembling the projectile shooting assembly 200, wherein FIG. 8A shows the pouch 202 assembled on the holder 220 by engaging the lip 224 in the groove 230. FIG. 8B shows the projectile shooting assembly with front cover 216 open ready to receive the holder 220 fitted with the pouch 202, also showing the recesses 240-1, 240-2 and 240-2 (collectively recesses 240) where the female lugs 242 of the rear pouch holder 236 shall engage. FIG. 8C shows the rear pouch holder 236 positioned within the housing with the female lugs 242 received within the recesses 240. FIG. 8D shows the front pouch holder 234 placed over the rear pouch holder 236 by engaging the male lugs 238 with the female lugs 242, as shown in FIG. 7A; and FIG. 8E shows the nozzle 204 placed in position with its narrower end facing the front side of the shooting assembly 200, and the front cover 216 closed, in which position the nozzle 204 projects out of the front cover 216 through the cover opening.

According to an embodiment, the nozzle 204 can be placed within the housing 208 in two different modes of fitment comprising a first mode of fitment with a narrower side of the nozzle 204 positioned towards front side of the projectile shooting assembly 200, i.e. the side on which the front cover 216 is placed, as shown in FIG. 8E. The first mode of fitment of the nozzle 204 is the position for use of the projectile shooting assembly 200. The converging narrower mouth of the nozzle 204 helps to reduce cone angle of the expelled projectiles. In a second mode of fitment, the nozzle 204 can be fitted with its larger end toward the front side, i.e. the side on which the front cover 216 is placed, of the projectile shooting assembly 200. The nozzle is configured such that when fitted in the second mode, it gets fully accommodated within the housing to enable closing of the cover opening of the front cover 216 by a front cap 218A, shown in FIG. 2A.

FIG. 9 illustrates a perspective view of the nozzle 204 showing its converging configuration with a narrower end and a larger end. According to an embodiment, the nozzle 204 can be a silicone nozzle.

Thus, the present disclosure provides an improved and lightweight insect eradication device that overcomes drawbacks of conventional devices for eradicating insects. The disclosed device 100 includes an ergonomically convenient to hold grip that can also store the projectiles, such as salt. The device 100 is easy to assemble and disassemble.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

We claim:

1. An insect eradication device, the device comprising:
a projectile shooting assembly configured to expel a projectile from a front side of the device; and
a grip assembly configured for detachable attachment to the projectile shooting assembly; the grip assembly comprising:
a grip comprising a ring shaped holding portion having an aperture, the holding portion configured to engage with an external circular lip on a rear side of the projectile shooting assembly when the projectile shooting assembly is inserted therein from a front side of the grip; and
a generally Y shaped locking member configured to be fitted on the grip such that, when fitted the on the grip, the locking member locks the projectile shooting assembly in position in engagement with the holding portion of the grip.

2. The device as claimed in claim 1, wherein the projectile is selected from a group consisting of: common table salt, coarse salt, rock salt, BBs, airsoft BBs, plastic balls, pellets, dirt and sand.

3. The device as claimed in claim 1, wherein the locking member and the grip incorporate matching male and female engagement features that allow the locking member to be slid up relative to the grip after the male and the female engagement features have been aligned, and wherein after the locking member has been fully moved up, an upper portion of the locking member overlaps with a front side face of the projectile shooting assembly to lock the projectile shooting assembly in position.

4. The device as claimed in claim 1, wherein the upper portion of the locking member is substantially semicircular to give the locking member the generally Y shape.

5. The device as claimed in claim 1, wherein the grip is hollow from inside, and the inner hollow is configured to store the projectile.

6. The device as claimed in claim 5, wherein the grip includes at least one opening to fill and remove the stored projectile from inner hollow, and wherein the grip further includes at least one silicon plug to close the at least one opening.

7. The device as claimed in claim 2, wherein the projectile shooting assembly comprises:
a generally round shape housing having a thickness along an axis of the housing, a front side and a rear side, both the rear side and the front side respectively having a rear opening and front opening that are concentric to the axis of the housing;
a pouch holder configured for being accommodated within the housing; and
a projection pouch configured for fitment at a rear end of the pouch holder such that when the pouch holder is accommodated within the housing a major portion of the projection pouch projects out through the rear opening of the housing,
wherein the projection pouch is configured such that when a rear tip of the projection pouch is pulled back and released, the projectile filled in the projectile shooting assembly gets expelled from the front side of the device to eradicate insects.

8. A projectile shooting assembly configured to expel a projectile from a front side of the projectile shooting assembly, the projectile shooting assembly comprising:
a generally round shape housing having a thickness along an axis of the housing, a front side and a rear side, both the rear side and the front side respectively having a rear opening and front opening that are concentric to the axis of the housing;
a pouch holder configured for being accommodated within the housing; and
a projection pouch configured for fitment at a rear end of the pouch holder such that when the pouch holder is accommodated within the housing a major portion of the projection pouch projects out through the rear opening of the housing,
wherein the projection pouch is configured such that when a rear tip of the projection pouch is pulled back and released, a projectile filled in the projectile shooting assembly gets expelled from the front side of the device to eradicate insects.

9. The projectile shooting assembly as claimed in claim 8, wherein the projectile shooting assembly comprises a front cover that is pivotally fixed to the front side of the housing, wherein the front cover having a cover opening that is concentric to the axis of the housing, and the front cover, when in a closed position, covers the front opening of the housing.

10. The projectile shooting assembly as claimed in claim 8, wherein the pouch holder is of annular shape and includes a groove on outer periphery near a rear end of the pouch holder, the groove being configured for fitment of a front end of the projection pouch.

11. The projectile shooting assembly as claimed in claim 8, wherein the rear end of the pouch holder is larger than a front end, such that the pouch holder works to converge the shot being expelled from the projectile shooting.

12. The projectile shooting assembly as claimed in claim 8, wherein the pouch holder includes a plurality of lugs located on an outer periphery of the pouch holder such that when the pouch holder is fitted within the housing, the plurality of lugs engage with corresponding recesses in the housing to locate the pouch holder in the housing.

13. The projectile shooting assembly as claimed in claim 10, wherein the pouch holder is a single piece construction.

14. The projectile shooting assembly as claimed in claim 10, wherein the pouch holder is a two piece construction comprising a front pouch holder that has a shape that converges toward the front side, and a rear pouch holder having the groove for fitment of the projection; and wherein the front pouch holder and the rear pouch holder are assembled to each other through a combination of male and female lugs provided on outer peripheries of the front pouch holder and the rear pouch holder respectively.

15. The projectile shooting assembly as claimed in claim 9, wherein the projectile shooting assembly further includes a cone shaped nozzle configured for fitment in the housing towards a front side of the pouch holder.

16. The projectile shooting assembly as claimed in claim 15, wherein the nozzle in a first mode of fitment is fitted with a narrower end towards the front side of the projectile shooting assembly, and wherein in the first mode of fitment the of the narrower end of the nozzle projects out of the front cover through the cover opening.

17. The projectile shooting assembly as claimed in claim 15, wherein the nozzle in a second mode of fitment is fitted with a larger end toward the front side of the projectile shooting assembly, and wherein the nozzle is configured such that in the second mode of fitment, the nozzle is fully accommodated within the housing to enable closing of the cover opening by a front cap.

18. The projectile shooting assembly as claimed in claim 8, wherein the projection pouch is reinforced with a plurality of longitudinally ribbed elements.

19. The projectile shooting assembly as claimed in claim 8, wherein the rear tip of the projection pouch is reinforced to protect against wear and tear.

20. The projectile shooting assembly as claimed in claim 8, wherein the projectile shooting assembly includes a rail or bracket provided on an upper side of the housing, the rail or bracket configured to receive at least one apparatus selected from a group consisting of a laser, a flash light, a pointer, an aiming apparatus, a camera, a phone and a LED light.
